(19) United States
(12) Patent Application Publication
(10) Pub. No.: US 2018/0020820 A1
(43) Pub. Date: Jan. 25, 2018

(54) ANTI-STATIC HAIR BRUSH

(71) Applicant: ForBabs, LLC, La Mesa, CA (US)

(72) Inventor: Annette Crone, La Mesa, CA (US)

(73) Assignee: ForBabs, LLC, La Mesa, CA (US)

(21) Appl. No.: 15/608,765

(22) Filed: May 30, 2017

Related U.S. Application Data
(60) Provisional application No. 62/364,252, filed on Jul. 19, 2016.

(51) Int. Cl. A46B 15/00; B05D 1/28

(52) U.S. Cl. CPC A46B 15/0018; B05D 1/28; A46B 15/0002; A46B 5/0095

(57) ABSTRACT

The invention is directed toward a hair brush with a replaceable anti-static insert having a plurality of removable anti-static sheets, such that a user can brush his or her hair, then merely peel off the uppermost sheet such that a new, clean sheet is ready for the next time the brush is used.

### CROSS-REFERENCE TO RELATED APPLICATIONS

The present application claims priority to U.S. Provisional Application No. 62/364,252 filed Jul. 19, 2016, entitled ANTI-STATIC HAIR BRUSH, the entire contents of which is hereby expressly incorporated by reference.

### FIELD

This invention relates to the general field of anti-static hair brushes, and more specifically toward a hair brush with replaceable insert having a series of anti-static sheets. To this end, a brush is provided with a bottom section that mates with a top section, and removably restrains an insert section with one or more anti-static, replaceable sheets, such that a user can brush his or her hair without imparting static electricity to the hair from the brush.

### BACKGROUND

Devices to straighten hair have been used in one form or another for over 5,000 years. Hair brushes were invented in the 1800's as an improvement over the traditional comb, with bristles arrayed over a three-dimensional surface rather than the fixed teeth of two-dimensional comb. While hair brushes proved more comfortable than combs for many users, a common problem that many users—particularly women with long hair—have with hair brushes is that the brush develops static electricity which it imparts to the hair. This static electricity leaves the hair with an electric charge and as likely charged items repel each other, so do the individual strands of hair, resulting in unmanageable hair.

Thus, there has existed a long-felt need for a hair brush that does not impart static electricity to its users.

### SUMMARY

The present invention discloses various embodiments of an anti-static hair brush with a replaceable insert, where the replaceable insert has a series of anti-static sheets that prevent static electricity from being transferred to a user's hair.

According to some embodiments, the invention provides a hygienic means by which a user can rid the brush of dust, oil and strands of hair every time they tear away a used sheet.

According to some embodiments, the invention provides a hygienic means by which a user can brush his or her hair without transferring static electricity from the brush to the hair.

According to some embodiments, the invention provides an insert with a multiplicity of anti-static sheets that can be peeled off individually after each use.

According to some embodiments, the invention provides a means for replacing the stacks of inserts easily and quickly.

According to some embodiments, the invention provides for other hair-related purposes that are not necessarily related to anti-static, this list including but not limited to flyaway hair, frizzy hair, use with head lice, dry shampoo solutions, hair oils, hair straightening solutions, fragrance enhancers to minimize odors for smokers, and anti-dandruff activities.

According to some embodiments, the invention is designed to use on pets to minimize odor, repel dirt and dander, repel flea and bugs, condition pet hair and pet fur.

According to some embodiments, the invention provides an economical means by which a person can effectively brush his or her hair in a hygienic manner without worrying about static electricity.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 shows one embodiment of an anti-static hair brush with anti-static sheet insert.

FIG. 2 shows one embodiment of an anti-static insert with anti-static sheets.

FIG. 3 is a perspective view showing one embodiment of an anti-static hair brush having a clam shell opening portion to receive the anti-static sheet insert.

FIG. 4 shows one embodiment of an anti-static hair brush pulled apart into its individual components and end loading of the anti-static sheet insert.

FIG. 5 is a top view of the anti-static hair brush of FIG. 4 partially connected.

FIG. 6 is a bottom view of the anti-static hair brush of FIG. 4 partially connected.

FIGS. 7 and 8 are an end view of the bottom section of the anti-static hair brush of FIG. 4, showing the bottom retaining lip that encloses the insert.

FIG. 9 is an end view of the top section of the anti-static hair brush of FIG. 4, showing the top retaining lip that encloses the insert

FIGS. 10A and 10B are views showing another embodiment of a brush for use with an anti-static insert.

### DETAILED DESCRIPTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

Static electricity, two words that are commonly associated with hair is the culprit for what people call fly away or frizzy hair. Hair with properties that are thin or fine are much more susceptible to static. Static electricity happens when two objects of different electrical charges are rubbed together and similar charges are transferred from one object to another. The hair brush is a conductor for transferring electrical charges that makes hair stand on end.

The present invention is directed to hair brush or styling tool that is designed to reduce static electricity and control flyaway hair during the hair styling process. To accomplish this, the hair brush includes one or more tear away anti-static sheets that have been impregnated or coated with an anti-static solution. The anti-static sheets are positioned proximate the bristles and contact the hair while it is being brushed.

In some embodiments, the hair brush includes multiple tear away layers of anti-static sheets. The multiple tear away layers may be part of a replaceable insert configured for attachment to the hair brush. In some embodiments, the anti-static sheets may also include a pull-tab for easy removal of the individual sheets. The sheets may be disposable. The anti-static sheets may also add a hygienic component to the brush.

The anti-static sheets may be made of any material suitable for being impregnated or coated with an anti-static solution. In some embodiments, the anti-static sheets are made of a non-woven fabric. In some embodiments, the sheets may also contain dry shampoo, hair oils, hair straightening solutions, keratin, or argon oil. The brush may be any suitable size. There are also embodiments of the anti-static hair brushes for pets (i.e., cats & dogs).

### REFERENCE NUMBERS USED IN THE FIGURES

1. Hair brush

2. Insert

3. Insert retaining section

4. Handle

5. Bottom retaining lip

6. Bottom base

7. Insert substrate

8. Insert sheets

9. Top connector

10. Top base

11. Top retaining lip

12. Top hook

13. Slit

14. Direction of connection

15. Catching tab

16. Insert bottom

17. Tear-away sheet, generally

18. Insert core

19. Insert base plate

20. Uppermost sheet

101. Pet Brush

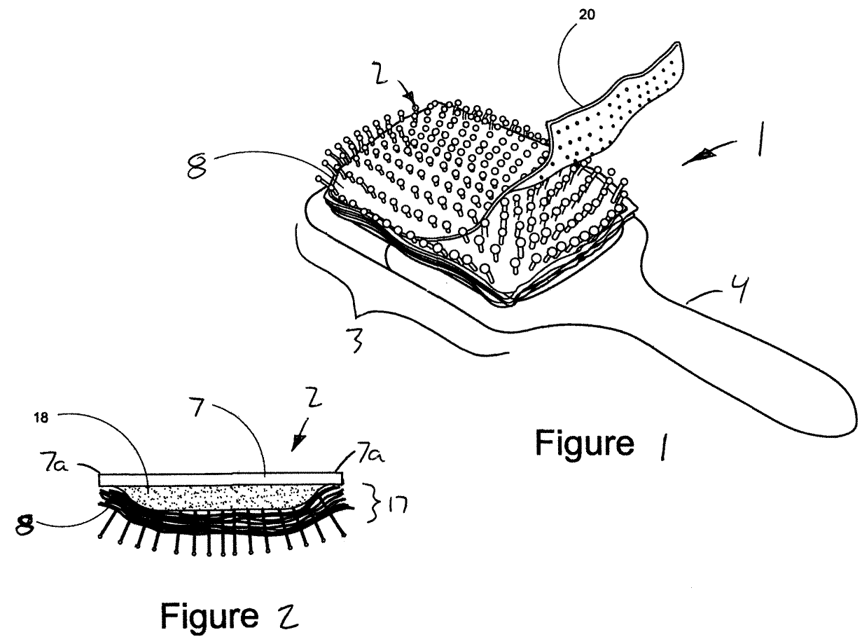

FIG. 1 is a perspective view showing one embodiment of an anti-static hair brush 1 having an anti-static insert 2 with anti-static sheets 8 positioned within an insert retaining section 3 of a handle 4. The anti-static insert 2 may contains multiple tear away layers or sheets 17, where an upper sheet 20 may be removed leaving a new layer or sheet exposed for the next use.

Anti-Static Insert

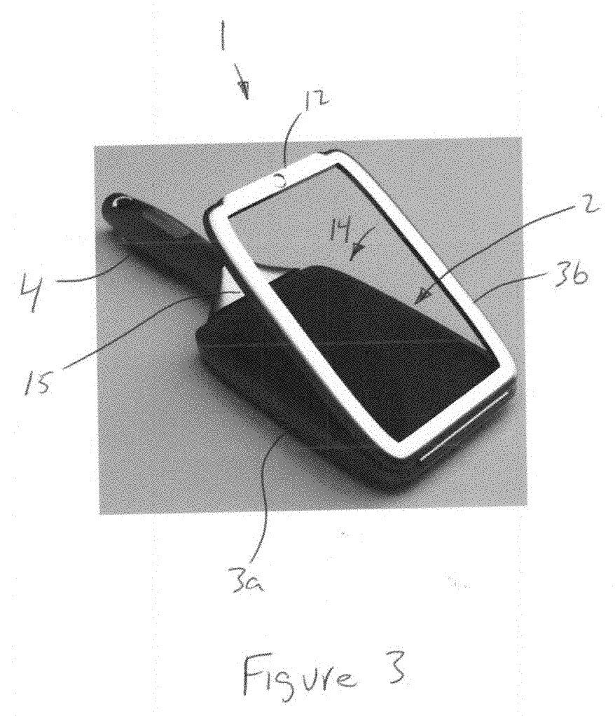

FIG. 2 shows one embodiment of an anti-static insert 2 having a base 7 over which the anti-static sheets 17 are positioned. The base 7 may be from made from any suitable rigid material, such as plastic, and configured to be inserted and retained within the retaining section 3 of the handle 4. The sheets 8 are anti-static in nature and prevent the transmission of static electricity from the hair brush to the hair of the user. In some embodiments, the base may include a soft core 18 over which the anti-static sheets 8 are positioned.

The anti-static sheets 17 are made using a substrate coating process to impregnate or coat the fabric with a proprietary anti static solution. The same substrate coating process can be used to impregnate or coat any suitable material with a liquid solution formulated to solve a specific hair grooming or health related hair problem.

The anti-static sheets are made into a multi sheet stack by pre populating the brush pad and bristles with multi layers of any material suitable for being impregnated or coated with anti static solution or any suitable solution related to the problem it intends to solve.

In some embodiments, the insert includes the brush bristles. The sheets may be replenished once all of them on the insert are used. The sheets may be slid over in over the bristles one at a time to form the multi sheet stack, or may be combined into the multi sheet stack before sliding over the bristles.

In some embodiments, the insert 2 has a base or bottom section called an insert substrate 7, upon which are stacked insert sheets 8. In some embodiments, the insert substrate has a rim 7a around the edge of the base 7 and is configured to fit within the retaining sections 3 of the brush.

It should be noted that these stacks of sheets can be used for purposes other than anti-static. For example, the sheets can also be used in the healthcare field. For example, anti-head lice medications can be impregnated into the sheets to assist in ridding a head of head lice during brushing. The sheets may also contain dry shampoo, hair oils, hair straightening solutions, keratin, or argon oil. Another example is the addition of perfume or some other scent to mask the odor of smoker's hair. In some embodiments, the hair brush may be used in the pet industry and the sheets may be impregnated with pet related solutions, such as anti-flea medications, or other health related additives.

Clam Shell Loading of Insert

FIG. 3 is a perspective view showing the anti-static hair brush 1 having a clam shell opening portions 3a, 3b in the open position for removing and replacing the anti-static insert 2. The brush 1 comprises a bottom section 3a, a top section 3b, and the insert 2. The bottom section 3a has a handle 4, which is gripped by the user. The top and bottom sections 3a, 3b are joined with a hinge at one end and a clasp or catch opposite the hinge holding the sections in the closed position. The hinge may be either molded with the top and bottom section, such as a flexible plastic hinge, or may be a separate hinge attached to the top and bottom sections. When closed in direction 14, the top section will mate with the bottom section, for example, a hook will snap into a mating receptacle in the bottom section, thereby removably trapping the insert between the top section and the bottom section.

The bottom section 3a may be open in the center with a perimeter retaining portion or lip 5, or may further include a bottom base 6 having a flat portion over which the insert 2 can sit along with the retaining lip 5, which is a rim that runs around the edges and bottom section of the base.

The top section 3b may be also open in the center with a perimeter retaining portion or lip 11, or may further include a top base 10, which is a flat portion over which the insert 2 can sit along with the top retaining lip 11 which is a rim that runs around the edges and bottom section of the base. The top section 3b also has a top hook 12 that can affix the top section 3b to the bottom section 3a. The top section 1 and bottom section 3 are pushed together, removably trapping the insert 2 under the bottom retaining lip 5 and the top retaining lip 11. The insert bottom 16 rests upon the bottom base 6 and the top base 10.

In use, the insert 2 is positioned within the top and bottom sections 3a, 3b and the sections are closed. Once the sections are closed, the rim 7a around the edge of the base 7 is sandwiched between the retaining lips 5, 11, holding it in place. To replace the insert 2, the top and bottom sections 3a, 3b are opened to release the insert.

End Loading of Insert

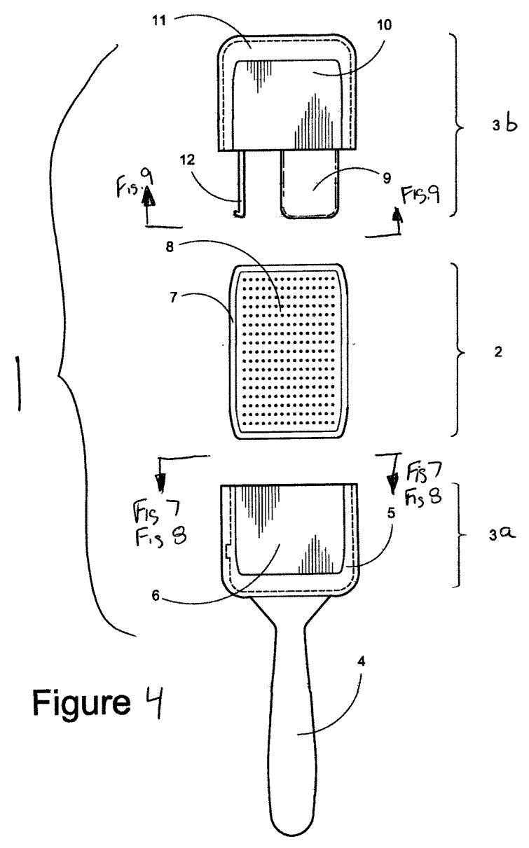

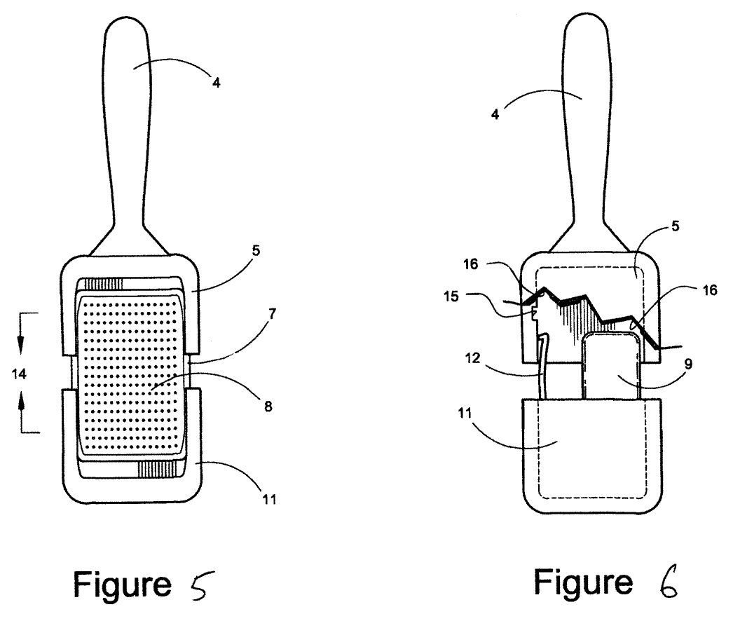

FIG. 4 is a top view of the invention pulled apart into its individual components. FIG. 5 and FIG. 6 are top and bottom views, respectively, of the invention as the parts are pushed toward each other to connect the top and bottom sections. The brush comprises a bottom section, generally referenced as 3a, a top section, generally referenced as 3b, and an insert, generally referenced as 2. The bottom section 3a has a handle 4, which is gripped by the user, a bottom base, which is a flat portion over which the insert 2 can sit, and bottom retaining lip 5, which is a rim that runs around the edges and bottom section of the base. The insert 2 has a bottom section called an insert substrate 7, upon which are stacked insert sheets 8, which are anti-static in nature and prevent the transmission of static electricity from the hair brush to the hair of the user.

The top section 3b has a top base 10, which is a flat portion over which the insert 2 can sit, and a top retaining lip 11 which is a rim that runs around the edges and bottom section of the base. The top section 3b also has a top hook 12 that can removably affix the top section 3 to the bottom section 3a. The top section 3a and bottom section 3b are pushed together, removably trapping the insert 2 under the bottom retaining lip 5 and the top retaining lip 11. The insert bottom 16 rests upon the bottom base 6 and the top base 10.

FIG. 5 is a top view showing the insert being restrained by the bottom section and the top section as they are pushed toward each other in direction 14. The bottom retaining lip 5 and the top retaining lip 11 cover the edge of the insert substrate 7a, effectively trapping it between the retaining lips and the base sections of the top and bottom. When fully pushed together in direction 14, the top hook (not shown in this figure) will snap into a mating receptacle in the bottom section (also not shown in this figure), thereby removably trapping the insert between the top section and the bottom section. After brushing their hair, users of the invention need only tear off the uppermost insert sheet 20 to have a clean and static-free insert sheet ready to use the next time they want to brush their hair. When they have used up all the insert sheets, they need only to unsnap the top section 3b from the bottom section 3a, and replace the insert 2.

FIG. 6 is a bottom view showing the bottom section and the top section as they are pushed toward each other in direction of connection 14. The top hook 12 of the top section 3b is being inserted into the bottom section, where it will removably latch to the bottom section at the catching tab 15.

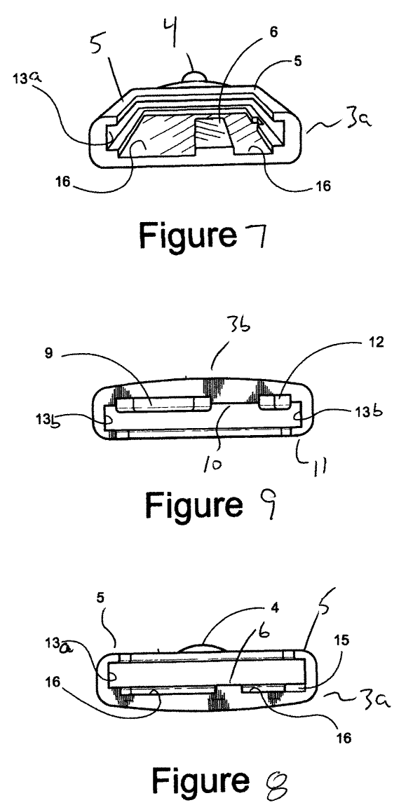

FIGS. 7 and 8 are end views of the bottom section 3a of the invention, showing the bottom retaining lip 5 that encloses the insert. The bottom retaining lip 5 extends over a cavity between the bottom retaining lip 5 and the bottom base 6. This cavity is called the bottom slit 13a. The insert base will slide into the bottom slit 13a and be restrained against movement by the bottom retaining lip 5.

FIG. 9 is an end view of the top section 3b of the invention, showing the top retaining lip 11 that encloses the insert. The top retaining lip 11 extends over a cavity between the bottom retaining lip 11 and the top base 10. This cavity is called the bottom slit 13. The insert base will slide into the top slit 13b and be restrained against movement by the top retaining lip 11.

The insert sheets 8 may be stacked underneath the hair brush bristles and it is contemplated that the sheets can be “tear-away” 17 such that after the user brushes his/her hair with the invention, the uppermost sheet 20 can be torn away and the next successive sheet below can be used for the next brushing. It is contemplated that the size and shape of the inserts can vary such that brushes of different shapes and dimensions can be used with inserts and not depart from the technology that is taught by this patent application.

Pet Brush

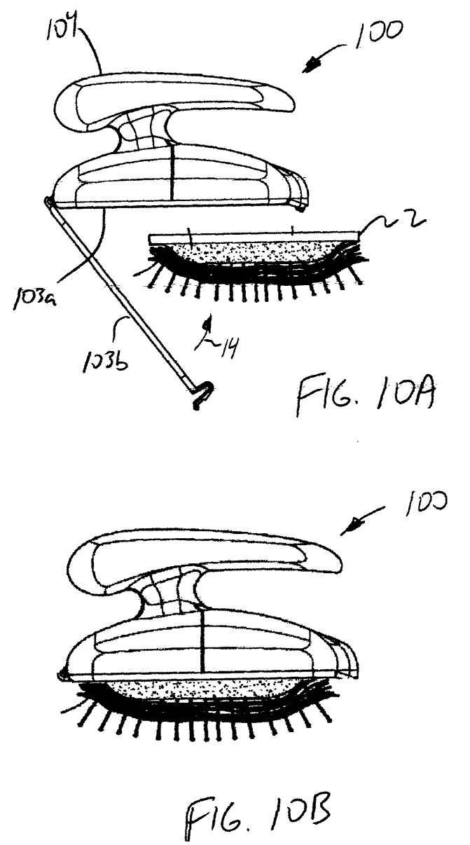

FIGS. 10A and 10B are views showing another embodiment of an anti-static brush 100 having a top section 103b, a bottom section 103a, and a handle 104, which is gripped by the user for use with an insert 2. FIG. 10A shows the anti-static brush 100 having a clam shell opening portions in the open position for removing and replacing the anti-static insert 2. The top and bottom sections are joined with a hinge at one end and a clasp or catch opposite the hinge holding the sections in the closed position. The hinge may be either molded with the top and bottom section, such as a flexible plastic hinge, or may be a separate hinge attached to the top and bottom sections. When closed in direction 14, the top section will mate with the bottom section, for example, a hook will snap into a mating receptacle in the bottom section, thereby removably trapping the insert between the top section and the bottom section. In use, the insert 2 is positioned within the top and bottom sections and the sections are closed retaining the insert 2, as shown in FIG. 10B. To replace the insert 2, the top and bottom sections are opened and the insert is removed and replaced.

It should be noted that these stacks of sheets can be used for purposes other than anti-static. For example, in the pet industry the sheets can have odor minimizing, anti-flea medications or other health and grooming related additives. The sheets can also be used in the human healthcare field. For example, anti-head lice medications can be impregnated into the sheets to assist in ridding a head of head lice. Another example is the addition of perfume or some other scent to mask the odor of smoker's hair.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What is claimed is:

1. A hair brush having hair treatment properties comprising:
a hair brush handle; and
a hair treatment insert coupled with the hair brush handle, the insert comprising:
a base; and
a plurality of hair treatment sheets having a substrate impregnated or coated with a hair treatment solution coupled to the base.

2. The hair bush of claim 1, wherein the hair treatment solution is selected from the group consisting of: anti-static solution, dry shampoo solution, hair oils, hair straightening solutions, head lice treatment solution, fragrance solution, anti-dandruff solution, solution to minimize odors and anti-flea medication.

3. The hair bush of claim 1, wherein the plurality of hair treatment sheets being configured as tear away hair treatment sheets assembled into a multi sheet stack configured to allow removal of one sheet at a time.

4. The hair bush of claim 1, wherein the insert further includes brush bristles coupled to the base, and the hair treatment sheets include multiple bristle openings configured to accept the brush bristles.

5. The hair bush of claim 4, wherein the hair treatment sheets may be slid over the bristles one at a time to form the multi sheet stack, or may be combined into the multi sheet stack before sliding over the bristles.

6. The hair bush of claim 1, wherein the hair brush handle includes brush bristles that extend through multiple bristle openings in the base and hair treatment sheets configured to accept the brush bristles.

7. The hair bush of claim 1, wherein the hair treatment insert is removably coupled with the hair brush handle and the hair brush handle includes hinged clam shell opening portions configured to receive or remove the hair treatment insert while in an open postion and retain the hair treatment insert in a closed position.

8. The hair bush of claim 1, wherein the hair treatment insert is removably coupled with the hair brush handle and the hair brush handle includes an insert receiving portion configured to receive and retain the insert.

9. The hair bush of claim 1, wherein the hair brush handle includes a hand strap coupled to the base.

10. A hair treatment insert for use with a hair brush handle comprising:
a base configured to couple with the hair brush handle; and
a plurality of hair treatment sheets coupled to the base, the sheets having a substrate impregnated or coated with a hair treatment solution.

11. The hair treatment insert of claim 10, wherein the hair treatment solution is selected from the group consisting of: anti-static solution, dry shampoo solution, hair oils, hair straightening solutions, head lice treatment solution, fragrance solution, anti-dandruff solution, solution to minimize odors and anti-flea medication.

12. The hair treatment insert of claim 10, wherein the plurality of hair treatment sheets being configured as tear away hair treatment sheets assembled into a multi sheet stack configured to allow removal of one sheet at a time.

13. The hair treatment insert of claim 10, further comprising brush bristles coupled to the base, and the hair treatment sheets include multiple bristle openings configured to accept the brush bristles.

14. The hair treatment insert of claim 10, further comprising brush bristles coupled to the base, and the hair treatment sheets further include multiple bristle openings configured to

15. An anti-static hair brush comprising:
a hair brush handle; and
an anti-static insert coupled with the hair brush handle, the insert comprising:
a base; and
a plurality of anti-static sheets impregnated or coated with an anti-static solution coupled to the base, the sheets being configured as tear away hair treatment sheets assembled into a multi sheet stack configured to allow removal of one sheet at a time.

16. The hair bush of claim 15, wherein the plurality of anti-static sheets being configured as tear away sheets assembled into a multi sheet stack configured to allow removal of one sheet at a time.

17. The hair bush of claim 15, wherein the insert further includes brush bristles coupled to the base, and the anti-static sheets include multiple bristle openings configured to accept the brush bristles.

18. The hair bush of claim 15, wherein the insert is removably coupled with the hair brush handle and the hair brush handle includes hinged clam shell opening portions configured to receive or remove the insert while in an open position and retain the insert in a closed position.

19. The hair bush of claim 15, wherein the insert is removably coupled with the hair brush handle and the hair brush handle includes an insert receiving portion configured to receive and retain the insert.

20. The hair bush of claim 15, wherein the hair brush handle includes a hand strap coupled to the base.
